(19) United States
(12) Patent Application Publication
(10) Pub. No.: US 2026/0284995 A1
(43) Pub. Date: Sep. 24, 2026

(54) ROTARY TABLET PRESS AND PRESSURE RAIL AS A CURVE SECTION OF A CONTROL CURVE FOR THE PUNCHES OF A ROTOR OF THE ROTARY TABLET PRESS

(71) Applicant: Romaco Kilian GmbH, Köln (DE)

(72) Inventors: Jens Carstens, Leverkusen (DE); Bernhard Kock, Moers (DE)

(21) Appl. No.: 19/164,495

(22) PCT Filed: Mar. 11, 2024
(86) PCT No.: PCT/IB2024/052325

§ 371 Date: Sep. 11, 2025

(30) Foreign Application Priority Data
Mar. 15, 2023 (DE) 20 2023 101 264.7

(51) Int. Cl. B30B 3/00; B30B 11/12

(52) U.S. Cl. CPC B30B 3/00; B30B 11/12

(57) ABSTRACT

A rotary tablet press having a rotor and having, distributed over the rotation path of the rotor, at least one filling station, a compacting station, and a discharge station, and having stationary control curves for controlling the movement of the upper punches and lower punches along the rotational path, wherein the control curves have several curve sections, and at least one curve section for the lower punches forms a pressure rail in the region of the compacting station that is at least partially inclined in the direction of rotation, the pressure rail for the lower punches in the compacting station having at least partially a curved upper side, along with a correspondingly designed pressure rail as a curve section of a control curve and pressure rollers are dispensed with and only pressure rails are used in the compacting station.

This Application claims priority in PCT application PCT/IB2024/052325 filed Mar. 11, 2024, which claims priority in German Patent Application DE 20 2023 101 264.7 filed on Mar. 15, 2023, which are incorporated by reference herein.

The invention relates to a rotary tablet press having a housing, a rotor arranged in the housing in a driveable manner, which rotor has an upper punch guide ring with guides for upper punches, a lower punch guide ring with guides for lower punches and a die disk arranged between the punch guide rings with dies for the manufacture of tablets or other pellets in the dies by means of the upper punches and lower punches, with at least one filling station, one compacting station and one discharge station distributed over the rotation path of the rotor for pellets manufactured in the dies, and with stationary control curves for the upper punches and the lower punches for controlling the movement of the upper punches and the lower punches along the rotation path, wherein the control curves have several curve sections distributed over the rotation path and at least one curve section for the lower punches forms, in the region of the compacting station, a pressure rail with a pressure rail body having an upper side which is designed to rise in the direction of rotation at least partially between a first location on the upper side and a second location spaced therefrom by an arc angle in the arc direction of the pressure rail body.

### BACKGROUND OF THE INVENTION

Rotary tablet presses or rotation tablet presses are used for manufacturing pellets as for example single-or multi-layered medical tablets, detergent tablets, etc. from a starting material mainly in powder form. The tablet presses have a rotating die disk, which is usually provided with a plurality of interchangeable dies in order to be able to manufacture different tablets/pellets with the same tablet press without changing the die disk. For each die, both an upper punch and a lower punch are provided, the up and down movement of which is guided in associated guide rings and controlled by stationary control curves or guide slots. In order to increase the number of dies in the die disk, it is known to form the die disk by means of several segments detachably attached to a rotor of the tablet press, and at the same time to provide only one bore in the respective segments instead of interchangeable dies, via which bore the size and shape of the tablet manufactured with this die disk is determined. At least one filling station, one compacting station and one discharge station are provided along the rotation path. In the filling station, the dies are filled with the material to be pressed, such as in particular powder. In the compacting station or compressing station, the material is pressed using the upper and lower punches and in the discharge station, the finished pressed pellets/tablets are discharged and forwarded to downstream stations outside the tablet press.

In most tablet presses used, pressure rollers are used in the compressing station, which rollers press against the appropriately designed heads of the lower punches and upper punches in order to compress the pressing material such as powder. In another design of rotary tablet presses, pressure rails can additionally be used. For example, reference is made to EP 1600285B1 or EP 2313259B1. EP 2313259 B1 uses a pressure rail for lower punches, the upper side of which initially rises in the direction of rotation along a straight line at a predetermined angle before the upper side of the pressure rail merges into a horizontal section. Pressure rollers are arranged in front of and behind the pressure rail, and the lower punches are provided with rollers to improve the sliding of the lower punches along the pressure rail. In EP 1600285B1, pressure holding rails are respectively located between a pre-press pressure roller and a main press pressure roller for the upper punches and the lower punches.

### SUMMARY OF THE INVENTION

It is the object of the invention to improve the compression of the starting material into tablets in rotary tablet presses.

For solving this object, the invention proposes, according to a first solution concept, that the pressure rail for the lower punches has a curved upper side at least partially between the first location and the second location. In a rotary tablet press with a pressure rail with a curved upper side, at least for the lower punches, a surprisingly significantly improved compression behavior of the starting material is observed due to the gradually increasing compression pressure caused by the curvature, which can be specifically influenced by the curvature of the upper side even over a comparatively short rotation path. The curvature of the pressure rail can correspondingly be used or modified for controlling the pressure gradient in the material to be compressed. At the same time, this enables a quick changeover when changing materials or dies.

The above object is correspondingly also solved by means of a pressure rail as a curve section of a control curve for the punches of a rotor of a rotary tablet press, in which the pressure rail has a pressure rail body with an upper side which preferably rises continuously between a first location of the upper side and a second location spaced therefrom in the arc direction of the pressure rail body by an arc angle in that the upper side is curved between the first location and the second location.

According to a particularly advantageous design, the curvature of the upper side can form a spline, preferably along the entire curvature. Alternatively, the curvature of the upper side can also form conical curves, preferably along the entire curvature. According to yet another alternative design, the curvature of the upper side can have several radii of curvature, in particular several radii of curvature which merge into one another in an essentially tangential manner.

In all designs of the pressure rail for the rotary press or a rotary tablet press equipped therewith, it is particularly advantageous if the local radius of curvature of the upper side preferably increases continuously from the first location to the second location.

Expediently, a single pressure rail with a curved upper side is used. Alternatively, the pressure rail for the lower punches could also consist of several segments. In this design, either each segment could have an upper side with a constant radius of curvature, or the segments following in the direction of rotation could have a larger radius of curvature than the segments preceding in the direction of rotation.

In all designs of the rotary tablet press mentioned above, the upper punches could, according to one design, be assigned a control curve for the upper punches, which has a pressure rail with a pressure rail body with at least a partially horizontal lower side along the rotation path, wherein the counter-pressure rail for the upper punches and the pressure rail for the lower punches are then conveniently arranged in the region of the pressure station along the rotation path in such a way that the curved region of the upper side of the pressure rail for the lower punches faces the horizontally extending region of the lower side of the counter-pressure rail for the upper punches.

According to an alternative design, the control curve for the upper punches could have a pressure rail with a pressure rail body with a lower side, wherein the lower side runs in a curved manner between a first location of the lower side and a second location spaced therefrom in the arc direction of the pressure rail body by an angle of curvature. By using a pressure rail with a curved upper side for the lower punches and a pressure rail with a curved lower side for the upper punches, the compression behavior of the material to be pressed can again be influenced better and thus also be improved overall, for example to achieve an even higher hardness of the tablet. In a pressure rail for the upper punches with a curved lower side, the curvature of the lower side could form a spline, preferably along the entire curvature. Alternatively, the curvature of the lower side could form conical curves, preferably along the entire curvature. According to yet another design, the curvature of the lower side could have several radii of curvature, preferably merging essentially into one another in a tangential manner. In this design, too, it can prove to be particularly advantageous if the local radius of curvature of the lower side preferably increases continuously from the first location to the second location.

In a rotary tablet press, only one control curve with a pressure rail with a curved upper or bottom side could be used, which may also interact with conventional pressure rollers in the main pressing station. In the particularly preferred design, however, only pressure rails and no pressure rollers are used for the upper punches and the lower punches in the main pressing station, and even more preferably in all compacting stations, of which at least one, and possibly all, have a curved sliding surface for interacting with the punches to apply the local pressing force.

The above object is solved in a generic rotary press according to a second aspect of the invention in that in the main pressing station and in each existing pre-pressing station for the upper punches and the lower punches only pressure rails and no pressure rollers are provided, and that the pressure rail for the lower punches in the main press station has a continuously rising upper side at least partially between the first location and the second location. By dispensing with pressure rollers and compacting the material exclusively by means of pressure rails which at least partially have a straight or curved rising upper side, the compression pressure on the material can increase slowly but steadily if necessary, wherein the compression pressure gradually increasing as the upper side rises can be specifically influenced by the design of the upper side of the pressure rail, even over a comparatively short rotation path. The design of the upper side of the pressure rail can be used or modified accordingly for controlling the pressure gradient in the material to be compressed. The upper side of the pressure rail can have sections with different pitch angles or sections with straight and curved profiles in order to influence the compression behavior for the material. This design of the pressure rails, particularly in the main pressing station, also enables a quick changeover when materials or dies are changed.

It is particularly advantageous if the upper side of at least one pressure rail of a pre-pressing station also has a continuously rising upper side at least partially between a first location and a second location. The upper side of the pressure rail for the lower punches in the main pressing station can, according to an embodiment variant, run in a straight line rising between the first location and the second location, and/or the upper side of at least one pressure rail of a pre-pressing station can at least run in a straight line rising at least partially between the first location and the second location.

The upper side of the pressure rail for the lower punches in the main pressing station can also be curved, and/or the upper side of the pressure rail for the lower punches in at least one pre-pressing station can also be curved.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 schematically in plan view, a rotary tablet press with the stations arranged along the rotation path;

FIG. 2 schematically, also considerably simplified, in a developed view, the rotation sequence of a rotary tablet press according to FIG. 1 according to a first embodiment variant, having a pressure rail with a curved upper side;

FIG. 3 schematically simplified in a perspective view, the pressure rail for the control curve in the main pressing station of a rotary tablet press pressure rail according to the invention with a curved upper side; and

FIG. 4 in a development the rotation sequence of a rotary tablet press according to a second embodiment variant, having a pressure rail with an upper side rising in a straight line.

### DESCRIPTION OF PREFERRED EMBODIMENTS

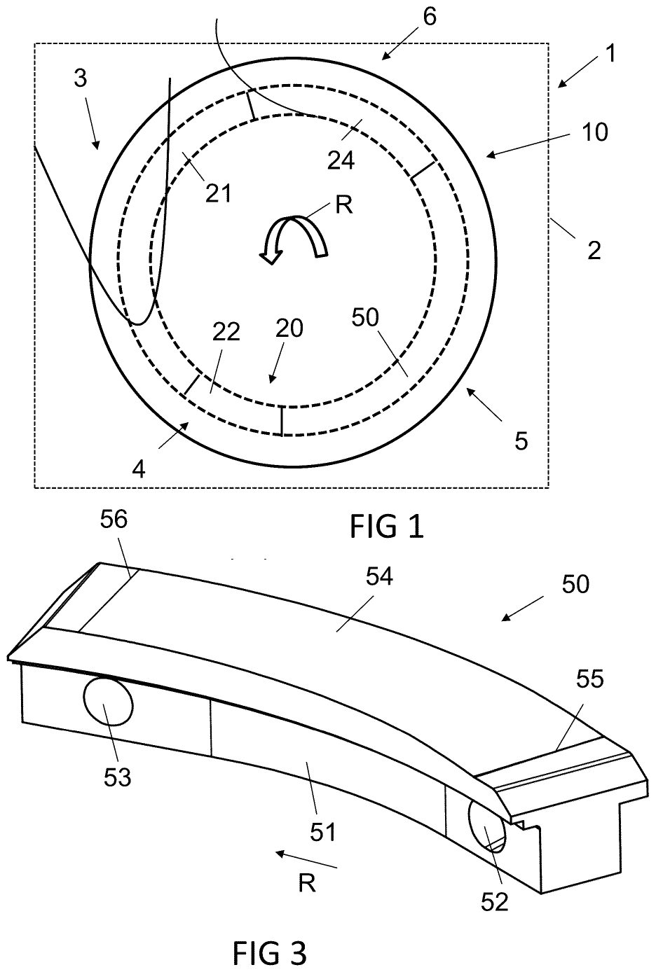

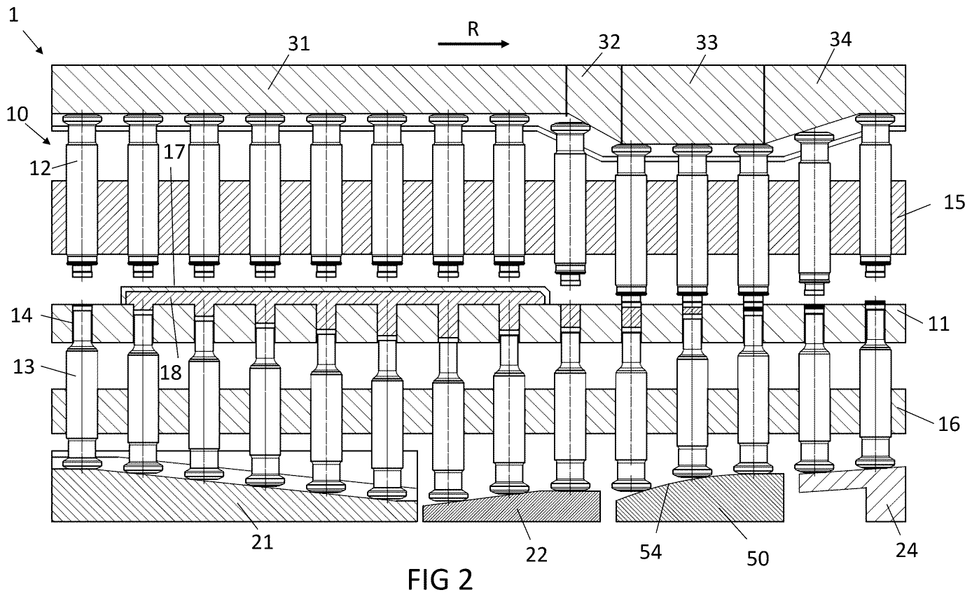

Referring now to the drawings wherein the showings are for the purpose of illustrating preferred and alternative embodiments of the invention only and not for the purpose of limiting the same, FIG. 1 shows, in a highly schematic plan view, a rotary tablet press, designated overall by reference numeral 1, for manufacturing tablets from a suitable starting material such as powder. The rotary tablet press 1 has a housing 2, within which a rotor 10 is arranged and rotatably supported, which can be driven in the direction of rotation R by means of a drive (not shown), as indicated by the arrow. The rotor 10 in turn has, as will be explained in more detail with reference to FIG. 2 and is shown there, a die disk 11 with a plurality of die receptacles 14 for dies arranged on a pitch circle, in which dies the starting material in powder form is pressed into tablets by means of cooperating upper punches 12 and lower punches 13. During the rotation of the rotor 10 in the direction of rotation R, the upper punches 12 and lower punches 13 pass through different stations. In the exemplary embodiment shown, the rotary tablet press 1 forms a monopress or a press for single-layer operation. Along the rotation path of the rotor 10, a filling station 3 is present, schematically indicated by a filling curve, in which the material in powder form to be compressed into the tablets is filled into the dies by means of suitable filling elements such as, for example, filling shoes, a dosing station 4, a compacting station 5 and a discharge station 6, symbolically indicated by a stripping rail. For each of these stations, the upper punches 12 and the lower punches 13 must be moved to different distances from each other, wherein this movement is controlled in the rotary tablet press 1 over the entire rotation by means of control curves. Different control curves exist for the upper punches 12 and the lower punches 13, wherein only the control curves 20 for the lower punches 13 are symbolically indicated in FIG. 1. All control curves 20 are arranged in the housing 2 in a stationary manner and, are divided into different curve sections corresponding to the station or the function of the rotary tablet press 1.

The symbolic representation in FIG. 1 shows altogether four curve sections for the lower punches, namely a pull-down and filling rail 21, a dosing rail 22, a pressure rail 50 and a discharge rail 24. This representation is only symbolic, because each of these rails could also be made up of several parts.

Reference is now made to FIG. 2, in which the development of the rotation path of the rotary tablet press 1 from FIG. 1 is shown and in which the upper punches 12 and lower punches 13 are correspondingly shown in different positions along the rotation path. The upper punches 12 are all movably guided in guides of an upper punch guide ring 15, and the lower punches 13 are movably guided in guides of a lower punch guide ring 16. The upper punch guide ring 15, the die disk 11 and the lower punch guide ring 16, form, together with the upper punch 12 and the lower punch 13, the essential components of the rotor 10. At the left edge of the picture begins the filling station, in which the lower punches 13 are moved downwards by means of the pull-down and filling rail 21 with the greatest possible distance from the upper punches 13, which are held in a most upwardly moved position by means of a filling station holding rail 31, whereby the powder 18 to be pressed can be moved, as indicated in FIG. 2, by means of a filling element 17 such as a filling shoe, into the dies closed downwards by means of the punch heads of the lower punches 13. Filling the dies takes some time, which is why the filling station extends over an extended angular range of the rotation path. A dosing rail 22 for the lower punches 13 is connected to the pull-down and filling rail 21 in the direction of rotation R, by means of which the lower punches 13 are moved upwards so that the filling volume of the material to be pressed is filled as precisely as possible into the dies between the head of the respective lower punch 13 and the upper side of the die disk 11. The dosing rail 22 can be assigned a vibrating element in order to improve the filling of the material in powder form into the dies which are open at the top and closed at the bottom by means of the pressing heads of the lower punches. The filling element 17 can in turn have a dosing edge in order to retain the (excess) material in powder form in the filling station or the filling element and to prevent it from rotating with the die disk 11. In the region of the dosing rail 22 for the lower punches 13, the downward movement for the upper punches 12 also begins, as indicated by the guide rail 32 for the upper punches 12, wherein the guide rail 32 effects an obliquely downward guide for the upper punches 12, which moves them downwards until the respective press head of the upper punch 12 dips into the dies.

The dosing station 4 or the dosing rail 22 is connected to the compacting or pressing station 5 in the direction of rotation R, which, in the rotary tablet press 1 is formed exclusively by means of pressure rails, as symbolically shown in FIG. 2 with a single pressure rail 50 for the lower punches 13 and a single counter-pressure rail 33 for the upper punches 12. The counter-pressure rail 33 holds the upper punches 12 in a position in which the punch head of the upper punches 12 dips sufficiently far into the die so that the entire pressing pressure within the dies can be applied to the material to be pressed. The pressing pressure itself is applied here via the lower punches 13 and the pressure rail 50 provided for moving these lower punches 13, which, as can already be clearly seen in FIG. 2, has at least partially a curved upper side 54 in the direction of rotation R. Due to the curved shape of the upper side 54 of the pressure rail 50, the pressing pressure can be applied in a non-linear manner and be gradually increased by the shape of the curvature.

Behind the pressing station 5, in the direction of rotation R, is connected the discharge rail 24 for the lower punches 13 and a lifting rail 34 for the upper punches 12, in order to expose the completely compressed tablet and to lift it by means of the lifting movement of the lower punches 13 in such a manner that the tablet can be moved radially outwards from the die table or the die disk by means of a stripping element and can be guided out of the housing 2 of the tablet press 1; here, as is known per se, a tablet outlet can also be provided, via which defective bad tablets are simultaneously sorted out.

The basic structure of a rotary tablet press with an upper punch 13 and a lower punch 12, which are moved by means of control curves and suitable rails in the filling station 3, in the dosing station 4 and in the discharge station 6, is known to the person skilled in the art, which is why it will not be discussed in detail here.

The innovations according to the invention in the rotary tablet press 1 primarily consist in that the entire pressing pressure is applied exclusively by means of one or more pressure rails in the tablet press 1, and that the pressure rail 50 has a curved upper side 54 in the embodiment variant in FIG. 2. For the simplicity, only a single pressure rail 50 for the lower punches 13 and a single counter-pressure rail 33 for the upper punches 12 are shown; multi-part pressure rails and/or counter-pressure rails could also be used for the corresponding function. The curvature of the upper side of the pressure rail 50 can be adjusted depending on the arc length and the desired curve for the pressing force. The counter-pressure rail 33 can also have a curved bottom side in order to influence the pressing force via the counter-pressure rail. The counter-pressure rail can also have a lower side extending obliquely and straight in the direction of rotation in order to increase the pressing pressure in the direction of rotation via the counter-pressure rail in addition to the curvature of the pressure rail for the lower punches. In the pressure rail 50, the curve section of the upper side extends only over a partial region, as the upper side 54 of the pressure rail 50 merges into a horizontal and straight section and preferably runs tangentially into this.

FIG. 3 shows an example of the structure of a corresponding pressure rail 50. The pressure rail 50 has a curved segment-like rail body 51 which is bent around the axis of rotation in an arc-shaped manner according to the curvature of the control curve and which is provided with holding bores 52, 53, via which the pressure rail can be fixed in a movement-proof manner to stationary anchor rods on the housing of the tablet press. The upper side 54 of the pressure rail body 51 is curved in such a manner that it rises continuously from a first location 55 to a second location 56, namely continuously here and with a curvature with preferably changing radius of curvature, e.g. according to a spline. The different thicknesses of the pressure rail body 51 clearly show this rise of the upper side 54 in FIG. 3. The curvature of the upper side 54 can also form conical curves or be logarithmic. The curvature can also extend over the entire length of this pressure rail 50, as several pressure rails can be arranged in the compacting station, wherein, if appropriate, only one of these pressure rails has a correspondingly curved upper side, whereas the other pressure rails can form curve sections in the compacting station with other functions. Thus, the curve sections in the compacting station can form a pre-pressing station and a main pressing station, and if necessary, only one of these pressing stations of the compacting station has a pressure rail with a curved upper side, whereas the other pressure rail has a continuously rising course and in a straight line of the upper side, or a straight horizontal course of the upper side, depending on which course is desired for the pressing pressure.

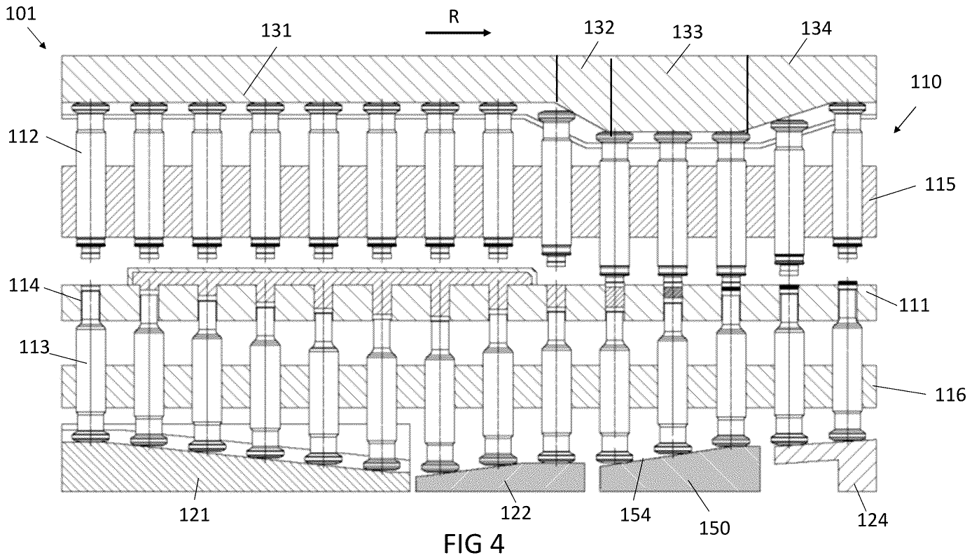

FIG. 4 shows an alternative embodiment of a rotary tablet press 101. As in the previous exemplary embodiment, a die disk 111 with die openings 114, an upper punch guide ring 115 for upper punches 112 and a lower punch guide ring 116 for lower punches 113 are provided, which together form the rotor 110 of the rotary tablet press 101. And here too, the movement of the upper punches 112 is controlled via the rails 131, 132, 133 and 134, and the movement of the lower punches 113 is controlled by means of the hold-down and filling rail 121, the dosing rail 122, a pressure rail 150 and a discharge rail 124, while the rotor 110 rotates in the direction of rotation R. Similar to the previous exemplary embodiment, there are no pressure rollers here either, but the entire pressing pressure is applied exclusively by means of the pressure rail 150 and the counter-pressure rail 134. However, here the pressure rail 150 has an upper side 154 which is not curved, but rises straight up to a location at which the pressure rail 150 changes into a horizontal course.

Numerous modifications will result for the person skilled in the art from the above description, which modifications shall fall within the scope of the appended claims. The exemplary embodiment shown only symbolizes the structure of a rotary tablet press according to the invention. Each curve section can consist of several sub-sections and correspondingly several sub-rails. Several rails can be arranged in the compacting station or pressing station, of which at least one pressure rail functions as a pre-pressing station and another rail functions as a main pressing station. The dies intended for manufacturing the tablets can also be formed integrally on the die disk. The above exemplary embodiments show a rotary tablet press for single-layer operation. The invention can also advantageously be used in a rotary tablet press as a double press or for multi-layer operation; (at least) two filling stations, two dosing stations and two compacting stations are then located along the rotation path, and in a double press two discharge stations. In a multi-layer press, one multi-layer tablet or core tablet is manufactured during one rotation using the same pair of punches; in a double press, 2, or possibly more, tablets are manufactured using the same pair of punches during one complete rotation of the rotor.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-15. (canceled)

16. A rotary tablet press having a housing, a rotor arranged in the housing in a driveable manner, which rotor has an upper punch guide ring with guides for upper punches, a lower punch guide ring with guides for lower punches and a die disk arranged between the punch guide rings with dies for the manufacture of tablets in the dies by means of the upper punches and lower punches, with at least one filling station, one compacting station and one discharge station distributed over the rotation path of the rotor, and with stationary control curves for the upper punches and the lower punches for controlling the movement of the upper punches and the lower punches along the rotation path, wherein the control curves have several curve sections distributed over the rotation path and at least one curve section for the lower punches forms, in the region of the compacting station, a pressure rail with a pressure rail body having an upper side which is designed to rise in the direction of rotation at least partially between a first location on the upper side and a second location spaced therefrom by an arc angle in the arc direction of the pressure rail body, wherein the pressure rail for the lower punches in the compacting station comprises, at least partially between the first location and the second location, a curved upper side.

17. The rotary tablet press according to claim 16, wherein the curvature of the upper side forms a spline, or that the curvature of the upper side forms conical curves.

18. The rotary tablet press according to claim 16, wherein the curvature of the upper side has several radii of curvature.

19. The rotary tablet press according to claim 16, wherein the curvature of the upper side has several radii of curvature merging substantially tangentially into one another.

20. The rotary tablet press according to claim 16, wherein the local radius of curvature of the upper side increases continuously from the first location to the second location.

21. The rotary tablet press according to claim 18, wherein the local radius of curvature of the upper side increases continuously from the first location to the second location.

22. The rotary tablet press according to claim 16, wherein the pressure rail for the lower punches consists of several segments.

23. The rotary tablet press according to claim 16, wherein the pressure rail for the lower punches consists of several segments, wherein each segment has an upper side with a constant radius of curvature and/or wherein the segments following in the direction of rotation have a larger radius of curvature than the segments preceding in the direction of rotation.

24. The rotary tablet press according to claim 16, wherein the control curve for the upper punches has a pressure rail with a pressure rail body with an at least partially horizontally extending lower side, wherein the pressure rail for the upper punches and the pressure rail for the lower punches are arranged in the region of the pressure station along the rotation path in such a way that the curved region of the upper side of the pressure rail for the lower punches is opposite the horizontally extending region of the lower side of the counter-pressure rail for the upper punches.

25. The rotary tablet press according to claim 16, wherein the control curve for the upper punches has a pressure rail with a pressure rail body with a lower side, wherein the lower side runs in a curved manner between a first location of the lower side and a second location spaced therefrom in the arc direction of the pressure rail body by an angle of curvature.

26. The rotary tablet press according to claim 25, wherein the curvature of the lower side forms a spline, or that the curvature of the lower side forms conical curves.

27. The rotary tablet press according to claim 25, wherein the curvature of the lower side, along the entire curvature, forms a spline, or that the curvature of the lower side, along the entire curvature, forms conical curves.

28. The rotary tablet press according to claim 25, wherein the curvature of the lower side has several radii of curvature, wherein the local radius of curvature of the lower side increases from the first location to the second location.

29. The rotary tablet press according to claim 25, wherein the curvature of the lower side has several radii of curvature merging substantially tangentially into one another, wherein the local radius of curvature of the lower side increases continuously from the first location to the second location.

30. The rotary tablet press according to claim 16, wherein the compacting station has a main pressing station and at least one pre-pressing station, wherein only pressure rails but no pressure rollers are provided for the upper punches and the lower punches in all pressing stations.

31. The rotary tablet press according to claim 30, wherein the upper side of at least one pressure rail of a pre-pressing station, at least partially between a first location and a second location, has a continuously rising upper side.

32. The rotary tablet press according to claim 30, wherein the upper side of the pressure rail for the lower punches in the main pressing station runs in a straight line rising between the first location and the second location, and/or the upper side of at least one pressure rail of a pre-pressing station runs, at least partially between the first location and the second location, in a straight line rising.

33. Rotary tablet press according to claim 30, wherein the upper side of the pressure rail for the lower punches in the main pressing station is curved.

34. A pressure rail as a curve section of a control curve for the punches of a rotor of a rotary tablet press according to claim 16, having a pressure rail body with an upper side which rises continuously between a first location of the upper side and a second location spaced therefrom in the arc direction of the pressure rail body by an arc angle, wherein the upper side is curved between the first location and the second location.
